(19) United States
(12) Patent Application Publication
(10) Pub. No.: US 2022/0132248 A1
(43) Pub. Date: Apr. 28, 2022

(54) DEVICES, SYSTEMS AND PROCESSES FOR AN ADAPTIVE AUDIO ENVIRONMENT BASED ON USER LOCATION

(71) Applicant: SLING MEDIA PVT LTD., Englewood, CO (US)

(72) Inventor: Rajashekhar Mandlur Basavarajappa, Bengaluru (IN)

(73) Assignee: SLING MEDIA PVT LTD., Englewood, CO (US)

(21) Appl. No.: 17/161,925

(22) Filed: Jan. 29, 2021

(30) Foreign Application Priority Data
Oct. 28, 2020 (IN) 202041046945

(51) Int. Cl. H04R 3/12; G06F 3/16; H04R 3/04; H04R 27/00; H04W 76/15

(52) U.S. Cl. CPC H04R 3/12; G06F 3/165; H04R 3/04; H04R 27/00; G01S 19/13; H04R 2420/07; H04R 2430/01; H04R 2227/005; H04R 2227/003; H04W 76/15

(57) ABSTRACT

A process, for adapting an audio environment based on a current user location includes initializing a wearable device with a hub, determining a device location, generating a sound property for content based on the location, adjusting a sound based on the sound property, obtaining device motion data, obtaining an updated device location, generating a second sound property, and adjusting a second sound based on the second sound property. The first location and the updated first location for may be determined by establishing a connection between the device and the hub, establishing a second connection between the device and a first access point, establishing a third connection between the device and a second access point, and calculating the locations by triangulating timing signals received by the device from the hub, the first access point, and the second access point. The sound properties may include first and second volume settings.

### CROSS-REFERENCE TO RELATED APPLICATIONS

This application claims priority to Indian Provisional application serial number 202041046945, filed on Oct. 28, 2020, in the name of inventor Rajashekhar Mandlur Basavarajappa, and entitled “Devices, Systems and Processes for Adaptive Audio Environment Based on User Location,” the entire contents of which are incorporated herein by reference.

### TECHNICAL FIELD

The technology described herein generally relates to devices, systems, and processes for providing an adaptive audio environment.

### BACKGROUND

Devices, systems, and processes are needed for providing an adaptive audio environment based on a user's current location. As used herein, a “user” and/or “listener” are used interchangeably to refer to those one or more persons with respect to whom a given audio presentation is to be presented. Often, a user will move about their home while desiring to listen to an audio presentation from different locations. The audio presentation may be provided by one or more speakers in the home. The speakers may be provided approximate to a specific location and/or throughout one or more locations in the home. For example, a speaker may be provided in a television and the audio presentation may include the audio portion of a television program. Two or more speakers may also be distributed throughout the home—as may be provided by a home or similar distributed audio system, where, for example, speakers may be used in a living room, bedroom, kitchen, or other location in a home to provide the audio presentation at more than one location in the home.

As the user moves about the home, the user's proximity to a given audio output device (herein, a “speaker”) will vary. Such varying distances often result in the listener being unable to hear the presentation, such as when far away from a given speaker, or the listener being immersed, overwhelmed, or otherwise adversely or undesirably receiving the audio presentation when the listener is at a different location. These occurrences often result in the listener repeatedly being situated in an undesirable audio environment, e.g., one where the sound is too soft, too loud, out of phase, or otherwise presented.

Further, other people (one or more “second persons”) commonly reside in a home. Such second persons may have their own audio listening preferences and needs. For example, a hearing diminished or otherwise fully or partially impaired person may need an audio environment to emphasize different volumes, frequencies, and mixes of sounds in order for such person to receive the given audio presentation in a manner acceptable to such second person. Further, such second persons may also vary their location within the home over time. Thus, a need exists for devices, systems, and processes for providing adaptive audio environments based upon one or more listener's current location and/or based on one or more listeners' audio preferences. A need also exists for devices, systems, and processes for providing an adaptive audio environment in multi-person homes.

### SUMMARY

The various implementations of the present disclosure relate in general to devices, systems, and processes for providing adaptive audio environments for a listener and/or for multiple listener environment. Other implementations may include corresponding computer systems, apparatus, and computer programs recorded on one or more computer storage devices, each configured to perform the actions of the process.

In accordance with at least one implementation, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a process. The process may include initializing a first wearable device with a hub, determining a first location for the first wearable device, generating a first sound property for a given content based on the first location, instructing a source to adjust a first sound based on the first sound property, obtaining first motion data for the first wearable device, obtaining an updated first location of the first wearable device, generating a second sound property based on the updated first location, and instructing the source to adjust a second sound based on the second sound property.

For at least one implementation, the first wearable device may include at least one of a smartphone, a smart watch, a laptop computer, and a fitness tracker.

The first location and the updated first location for the first wearable device may be determined by: establishing a first wireless connection between the first wearable device and the hub; establishing a second wireless connection between the first wearable device and a first access point; establishing a third wireless connection between the first wearable device and a second access point; and calculating the first location and the updated first location by triangulating timing signals communicated respectively between the first wearable device with the hub, the first access point, and the second access point over the first wireless connection, the second wireless connection, and the third wireless connection.

At least one of the first location and the updated first location may be determined by a global positioning system receiver in the first wearable device.

For at least one implementation, a first sound property may be a volume setting for a first speaker. A second sound property may be a second volume setting for the first speaker. The adjusting of the second sound property may include an increase in a volume setting when the first user preference indicates a first user of the first wearable device is hearing impaired. An adjusting of the second sound property may include a reduction in the volume setting when the updated first location is associated with a bedroom.

For at least one implementation, a process may include: initializing a second wearable device with the hub; obtaining a second location for the second wearable device; generating a third sound property for the given content based on the second location; instructing the source to adjust the first sound based on at least one of the first sound property and the third sound property; obtaining second motion data for the second wearable device; obtaining an updated second location of the second wearable device; generating a fourth sound property based on the updated second location; and instructing the source to adjust the second sound based on at least one of the second sound property and the fourth sound property. The second user preference may indicate that a second user of the second wearable device is a child. The adjusting of the second sound property may include muting sounds based on the updated second location.

One general aspect includes a process for generating, by a hub, a first sending time indicator and instructing a source to include the first sending time indicator in a first sound output by a first speaker. The process may also include receiving, from a wearable device, a first receiving time indicator for the first sound, calculating based on the first sending time indicator and the first receiving time indicator a first sound distance of the wearable device from the first speaker, and based on the first sound distance, identifying a sound property to be adjusted. The process may include instructing a source to adjust a second sound based on the identified sound property. The adjusted second sound may be output by the source and via the first speaker.

Implementations may include one or more of the following features of a process that may include operations for adjusting the sound property based upon a first user preference. The adjusting of the sound property may include an increase in a volume setting when the first user preference indicates a first user of the first wearable device is hearing impaired. The process may include generating, by the hub, a second sending time indicator; instructing the source to include the second sending time indicator in a second sound output by a second speaker. The process may include one or more operations of generating, by the hub, a third sending time indicator, instructing the source to include the third sending time indicator in a third sound output by a third speaker, receiving, from the wearable device, a second receiving time indicator for the second sound, calculating based on the second sending time indicator and the second receiving time indicator a second sound distance of the wearable device from the second speaker, receiving, from the wearable device, a third receiving time indicator for the third sound, calculating based on the third sending time indicator and the third receiving time indicator a third sound distance of the wearable device from the third speaker, and determining, by triangulation of the first sound distance, the second sound distance and the third sound distance, a location of the wearable device.

One general aspect includes a system that includes a first wearable device associated with a first user, a source having a sound processor operable to generate a first sound, a speaker, coupled to the source, operable to output the first sound, and a hub, coupled to the source and to the wearable device. The hub may include a processor executing non-transient computer instructions for determining a first location and a second location of the first wearable device. The instructions may include those for instructing the source, based on the first location and the second location, to adjust a sound property of the first sound.

Implementations may include one or more of the following features in a system where the sound property is a volume setting, and where the hub instructs the source to set the volume setting at a first setting when the first location is within a first range of the hub. The hub may be operable to instruct the source to set the volume setting at a second setting when a second location is within a second range of the hub. The sound property may be a frequency setting for the first sound.

For an implementation, non-transient computer instructions may include instructions for obtaining a user preference for the first user and instructing the source to adjust the sound property based on the user preference for the first user.

For an implementation, the wearable device may include a global positioning system (GPS) receiver. The wearable device may be operable to communicate a current location of the user to the hub as determined based on GPS position determinations. The hub may be operable to communicate a first timing signal to the wearable device.

For an implementation, the system may include a first access point, communicatively coupled to the wearable device, operable to communicate a second timing signal to the wearable device. A second access point may communicatively coupled to the wearable device and operable to communicate a third timing signal to the wearable device. At least one of the hub and the wearable device may be operable to determine a current location of the user based upon a triangulation of a first distance, a second distance, and a third distance. The first distance may be based upon a first time difference between when the first timing signal was sent and received by the wearable device. The second distance may be based upon a second time difference between when the second timing signal was sent and received by the wearable device. The third distance may be based upon a third time difference between when the third timing signal was sent and received by the wearable device.

The source may be operable to generate a second sound. The system may include a second speaker, coupled to the source, operable to output the second sound and a second wearable device, coupled to the hub, associated with a second user. The non-transient computer instructions may include instructions for obtaining a second user preference for the second user, determining a third location of the second wearable device, and instructing the source, based on the third location, to adjust the sound property of the second sound. The hub may be provided in combination with the source. Implementations of the described techniques may include hardware, a method or process, or computer software on a computer-accessible medium.

### BRIEF DESCRIPTION OF THE DRAWINGS

The features, aspects, advantages, functions, modules, and components of the devices, systems and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1A is an illustrative diagram of an implementation in a house of a system for providing an adaptive audio environment using a speaker location, in view of a user's current location, and in accordance with at least one implementation of the present disclosure.

FIG. 1B is an illustrative diagram of an implementation in a house of a system for providing an adaptive audio environment using multiple speaker locations, in view of a user's current location, and in accordance with at least one implementation of the present disclosure.

FIG. 1C is an illustrative diagram of an implementation in a house of a system for providing an adaptive audio environment using multiple speaker locations, in view of multiple user's current locations, and in accordance with at least one implementation of the present disclosure.

FIG. 2 is a schematic diagram of system components for use in a system for providing an adaptive audio environment based on user location and in accordance with at least one implementation of the present disclosure.

FIG. 3 is a flow chart illustrating a process for providing an adaptive audio environment based on a user location in accordance with at least one implementation of the present disclosure.

FIG. 4 is a flow chart illustrating a process for providing an adaptive audio environment based on a sound distance of a user and in accordance with at least one implementation of the present disclosure.

### DETAILED DESCRIPTION

The various implementations described herein are directed to devices, systems, and processes for providing adaptive audio environments based on user location. As described herein, the various implementations of the present disclosure are directed to determining a user's then occurring/given location and, in response thereto, providing an adaptive audio environment.

In accordance with at least one implementation, a user's audio environment may be adapted by changing a sound produced by one or more speakers based upon a user's then arising given location, locations of speakers in a home, in view of one or more second user's then arising “second given” locations, in view of one or more user's audio preferences, combinations of the foregoing, and otherwise. The one or more speakers may be distributed throughout a home or provided at a location within the home.

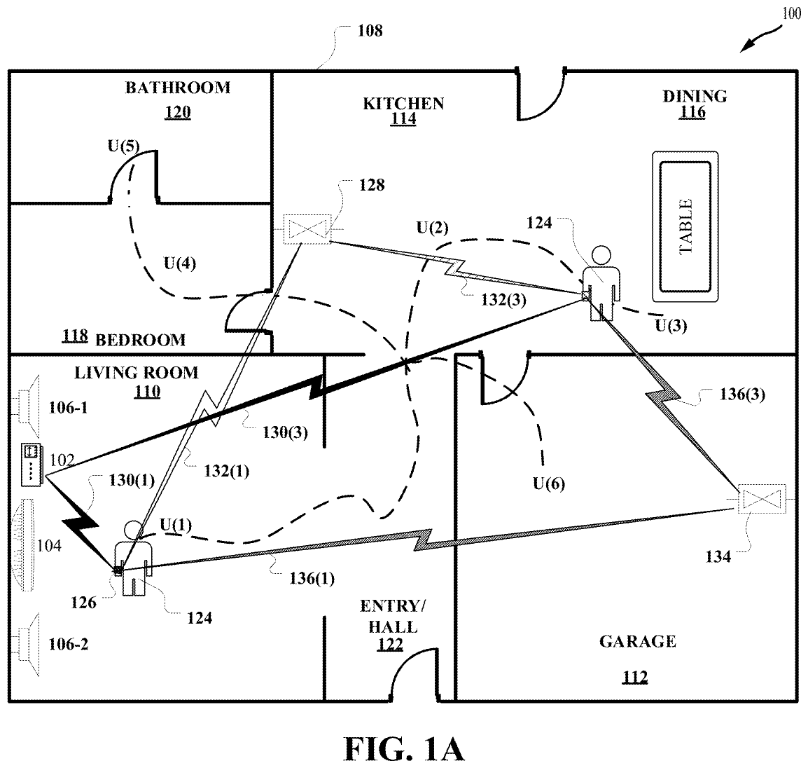

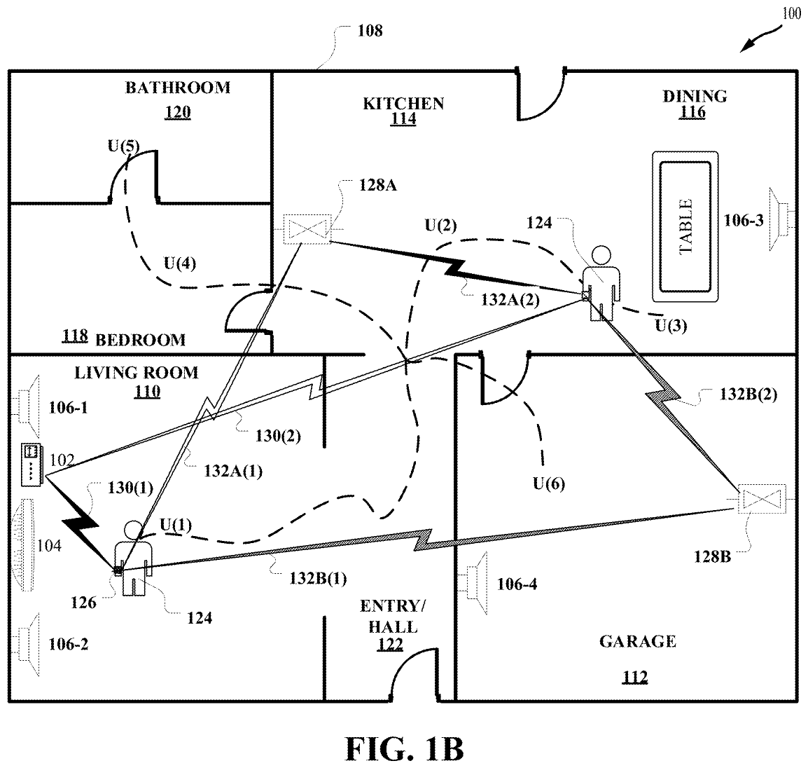

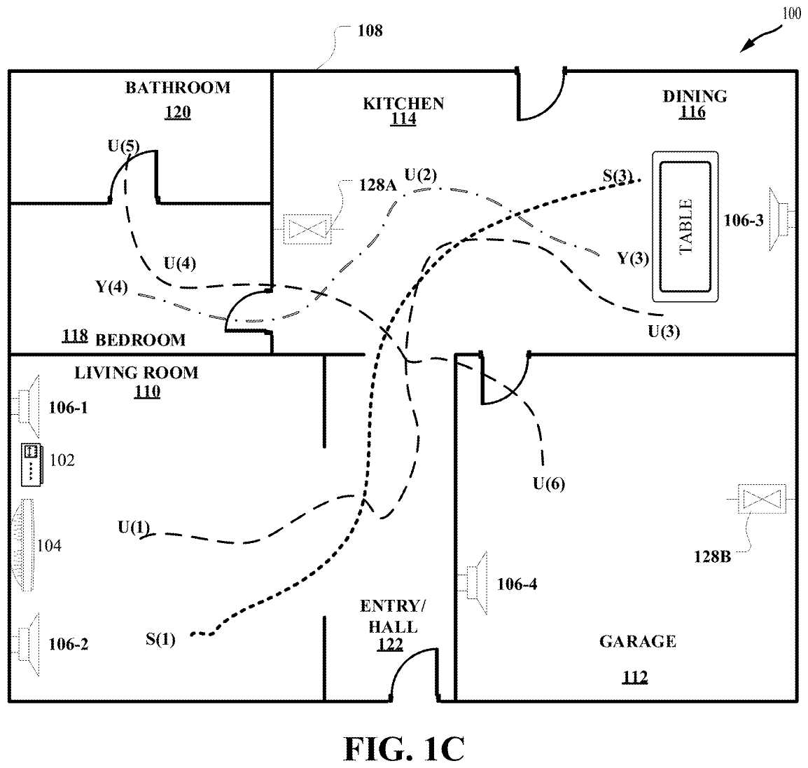

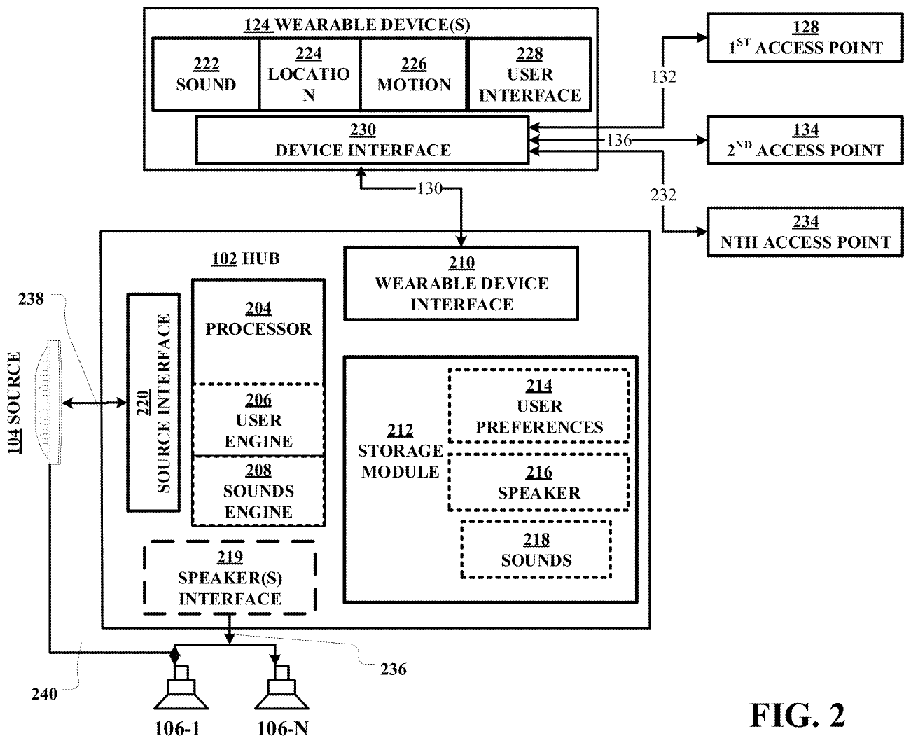

As shown in FIG. 1A and for least one implementation of the present disclosure, a system 100 for providing an adaptive audio environment to a user 124 may include a hub 102. A non-limiting example of the hub 102 is further described below and with respect to FIG. 2. The hub 102 is coupled to and/or provided in combination with a source 104.

The source 104 may be any device that includes a sound processor, amplifier, and other commonly known components that are operable to generate audio sounds for outputting by a speaker 106 associated with or coupled to the source 104. Non-limiting examples of sources 104 include televisions, stereo receivers, cable set top boxes, 10-foot devices, satellite receivers, gaming devices, personal computers, tablet computing devices, smartphones, and any other device or collection of devices capable of outputting humanly perceptible sounds based on a given content. The content may be of any form or nature, provided it includes or is capable of being converted into one or more audio waveforms. Non-limiting examples of content include motion pictures, television shows, videos, streaming music, text-to-speech, e-readers, and the like.

As used herein, “audio” and/or “sounds” include any vibration of a fluid, such as the air, water, or the like which originates from content received by, generated by, and/or processed (herein, “audio processing”) by a source in an audio file format. Examples of audio file formats including, but not limited to, WAV, AIFF, AU, RAW, PCM, MPEG-4 SLS, MPEG-4 ALS, MPEG-4 DST, WMA, AAC, and any other known or later arising audio file format. The sounds, after audio processing by a source, are provided to a speaker or other output mechanism at one or more frequencies. As used herein for at least one implementation, such frequencies may include any humanly perceptible frequency, such as those between twenty hertz (20 Hz) and twenty-thousand hertz (20,000 Hz) (herein, “perceptible sounds”). Frequency ranges above or below the perceptible sound frequencies may also be generated by speakers, or other devices (such frequencies being herein, “beyond perceptible sounds”). Beyond perceptible sounds may be used in generating environmental responses associated with a given sound or collection of sounds, such as the generation of vibrations, ringing in other devices, or the like. As used herein for at least one implementation, “sounds” may include perceptible sounds, beyond perceptible sounds, and/or combinations of perceptible sounds and beyond perceptible sounds.

“Sounds” include one or more “sound properties.” A sound property may include, but is not limited to, any characteristic of a sound produced by a speaker or other output device. Non-limiting examples of sound properties include volume settings, frequencies used, mixture of frequencies, reverberation, amplitude, direction, time-period, timbre, envelope, phase, and the like. Sound properties may include phonetic and/or linguistic properties of human speech including, but not limited to, language spoken, dialect, translations, phonemes utilized, pace of speech, and the like.

As used herein, an “environ” is a location and surrounding area about which one or more users move over two or more distinct periods and with respect to which an adaptive audio environment is provided or to be provided. An environ may include a structure and one or more surrounding areas. Non-limiting examples of environs include a home with a surrounding area including one or more of a yard, a garage, a patio, a swimming pool, or the like. An environ may or may not include a surrounding area. Public spaces, such as parks, offices, stadiums, and the like may also be an environ when such area includes a system capable of providing an adaptive audio environment to one or more users. Further, herein an “environ portion” or “portion” may include a room or other separately identifiable area or portion of an environ. For example and not by limitation and as shown in FIG. 1A, portions of a home environ may include a living room 110, attached garage 112, kitchen 114, dining area 116, bedroom, 118, bathroom 120, and the like.

Referring again to FIG. 1A, the source 104 may be coupled to one or more speakers 106-M where “M” is an integer. As used herein, a “speaker” is any device capable of producing sound.

The hub 102 is further coupled to a wearable device 126, associated with the user 124. A non-limiting example of a wearable device 126 is further described below and with respect to FIG. 2. A wearable device 126 may be provided as a separate device and/or in combination with another portable wireless device, such as a smartphone, smartwatch, tablet, laptop computer, personal computer, fitness tracker, or other device operable to wirelessly communicate with the hub.

The coupling of the hub 102 with a given wearable device 126 may occur by use of a first wireless connection 130. The wearable device 126 may also be coupled to one or more access points, including a first access point 128 and a second access point 134, using second wireless connections 132 and third wireless connections 136. An access point 128/134 may be wired and/or wirelessly coupled to the hub 102.

In FIG. 1A, a first wireless connection between a hub 102 and a wearable device 126 is designated by the number “130” and a user location identifier “N” in parenthesis, where N is an integer. For at least one implementation, “N” may be further expressed in terms used for any given location system, such as by latitude and longitude, based upon portions of an environs (for example, the living room 110 being designated portion “1” while the dining area 116 is designated as a portion “3”), based upon distances from a hub 102, or otherwise. For ease of identification in FIG. 1A, the first wireless connections 130(N) are shown with a solidly filled lightning bolt (indicating a wireless communication path). For example, 130(1) and 130(3), where “1” indicates a first user location and “3” indicates a second user location.

A second wireless connection 132(N) may be established between a given wearable device 126 and the first access point 128. For ease of identification in FIG. 1A, the second wireless connections 132(N) are shown with a hollow/non-filled lightning bolt.

A third wireless connection 136(N) may be established between a given wearable device 126 and a second access point 134. For ease of identification in FIG. 1A, the third wireless connection 136(N) are shown with a pattern filled lightning bolt.

For at least one implementation, a wearable device 126 may be communicatively coupled to the hub 102 and/or one or more of the first access point 128 and/or second access point 134, using any known or later arising communications technology, with non-limiting examples of such communications technologies including BLUETOOTH, WIFI, or the like. For at least one implementation, a wearable device 126 may be uni-directionally coupled to one or more points, such as to receive a timing or other signal from an access point, while being bi-directionally coupled to a hub 102.

The hub 102 may be operable to adjust one or more sound properties by instructing the source 104 and/or the one or more speakers 106-M accordingly. For example, the hub 102 may be operable to instruct the source 104 to increase the output volume of the first speaker 106-1 and/or the second speaker 106-2 when the user is at another location.

For at least one implementation, the hub 102 may be further operable to adjust sound properties based upon a current location of a given user 124 and relative to one or more given speakers, such as a first speaker 106-1 and/or a second speaker 106-2. As used in FIGS. 1A and 1B, a location of a given user “U” is further identified by the label (“N”). As shown in FIG. 1A and for purposes of illustration, user location U(1) is in the living room 110, U(2) is in the kitchen, U(3) is in the dining area 116, U(4) is in the bedroom 118, and U(5) is in the bathroom 120, and U(6) is in the garage 112. As further shown, first wireless connection 130(1), second wireless connection 132(1), and third wireless connection 136(1) are shown as respectively coupling the wearable device 126 with the hub 102, the first access point 128, and the second access point 134, when the user is at location U(1). Similarly, first wireless connection 130(3), second wireless connection 132(3), and third wireless connection 136(3) are shown as respectively coupling the wearable device 126 with the hub 102, the first access point 128, and the second access point 134, when the user 124 is in the dining area 116 and at location U(3).

For at least one implementation, ranging signals may be used by the wearable device 126 and with respect to the hub 102, the first access point 128, and the second access point 134 to determine the then arising/current position of the wearable device 126 (and thereby the current position of the user 124). Known principles of ranging and triangulation may be used to determine a current position of a wearable device 126/user 124 based on time differences, and the like. For at least one implementation, a wearable device 126 may be configured to include a microphone or other receiver and is operable to determine a current location thereof based upon timing signals provided in a sound produced by a speaker 106-M and a delay between a time of outputting of such sound by the given speaker and a time of reception of such sound by the wearable device 126.

For an implementation, global positioning system (GPS) and other known and/or later arising positioning technologies, and/or combinations thereof and GPS receivers and other commonly known components may be used to determine a current location of a wearable device 126. For at least one implementation, such location determination may be accomplished with any given positional error range. For example, a location of a wearable device 126 may be determined within an accuracy of a given number of centimeters, meters, or otherwise. For at least one implementation, a determination of a current location of a wearable device 126 is accurate to within three meters (+/−3 m). A determination of a current location of a wearable device 126 may occur on any basis, such as, continually, periodically, or otherwise. For at least one implementation, wearable device 126 location determinations may be accomplished by the hub 102 based upon ranging signals received by a wearable device 126 and communicated, using the first wireless connection 130, to the hub 102. For another implementation, wearable device 126 location determinations may be accomplished by the wearable device 126, based upon ranging signals received by the wearable device 126 from the hub 102 and two or more access points, and with such location determination then being reported to the hub 102 using the first wireless connection 130 and/or a second or third wireless connection. For at least one implementation, wearable device 126 location determinations are accomplished based upon reception of at least three wireless signals. For at least one implementation, such at least three wireless signals may be received over the first wireless connection 130. For an implementation, such at least three wireless signals may be received over the second wireless connection 132, the third wireless connection 136 and a (not shown) fourth or greater wireless connection. It is to be appreciated that for at least one implementation a first wireless connection 130 may not be established between the wearable device 126 and the hub 102 for a given current location.

The wearable device 126 may be operable to communicate received ranging signal information, location determinations, and/or other data to the hub 102 on any basis, interval, frequency, event occurrence, non-event occurrence, or otherwise including, but not limited to, continually, periodically, upon a change in location of the wearable device of a distance greater than a location change threshold (where, for at least one implementation, such location change threshold may be predetermined), upon user input, in response to a query by the hub, upon a detection of a user's change of state (for example and not by limitation, a user falling to sleep or falling down), or otherwise.

Based upon a determination of a current location of a given wearable device 126, the hub 102 may be operable to adjust one or more sound properties as output by one or more speakers 106-M and within a given environ or a portion thereof. For example, when the current location of a wearable device 126 is location U(1) (e.g., in the living room 110), the hub 102 may be configured to modify a sound property, such as reducing a volume of sound output by the first speaker 106-1 and second speaker 106-2. When the current location of the wearable device 126 is location U(3) (e.g., in the dining area 116), the hub 102 may be configured to increase the sound volume of one or more speakers 106-M to a second, third or other setting. For at least one implementation, a determination of a user's current location being

Similarly, when the current location of the wearable device 126 is U(6) (e.g., in the garage), the hub 102 may be configured to stop outputting the sound, increase the sound volume to another setting, increase amplitudes of one or more frequencies attenuated by walls separating the first speaker 106-1 and second speaker 106-2 from the garage 112, or otherwise adjust a sound property. Similarly, when the wearable device 126 is at location U(4) (e.g., in the bedroom 118), the hub 102 may be configured to reduce the volume of the sound, change the content of the sounds, such as by selecting a wave crashing or similar soundtrack conducive to sleeping, or otherwise adjusting one or more sound properties such that a sound environment is conducive to sleeping or other activities. Similarly, when the wearable device 126 is at location U(5) (e.g., in the bathroom 120), one or more sound properties may be adjusted.

For at least one implementation, adjustments of one or more sound properties may be accomplished by the hub 102 suitably instructing the source 104, which in turn adjusts electrical signals provided to speakers 106-M. In other implementations, adjustments of one or more sound properties may be accomplished by the hub 102 directly adjusting settings of one or more speakers 106-M.

The hub 102 may be further operable to adjust one more sound properties output by one or more speakers 106-M based upon one or more preferences associated with a given user (herein, “user preferences”).

As shown in FIG. 1B and for at least one implementation, a house 108 may include multiple speakers, situated in two or more locations. For example, the third speaker 106-3 may be providing in a dining area, fourth speaker(s) 106-4 may be located in the garage 112, and the like. Based upon a current location of a wearable device 126, the hub 102 may be operable to adjust one or more sound properties output by one or more speakers 106. For example, when the wearable device 126 is at the third location U(3), the hub 102 may activate the third speaker 106-3 while phase shifting, delaying, or otherwise modifying sounds produced by the third speaker 106-3 or other speakers then active, such that sounds received by the user from one or more additional speakers, such as first speaker 106-1 and/or second speaker 106-2, are in phase with sounds output by the third speaker 106-3 and vice versa. It is to be appreciated, that such one or more sound property modifications may be performed in view of predetermined distances between speaker locations, acoustic properties of a given environ and portions thereof, based upon audio properties associated with a given content being received from the source 104, and otherwise. For at least one implementation, sound properties of sounds outputted by two or more speakers 106-M may be modified based upon a determined location of a given wearable device 126 including while such determined location is changing and/or non-changing.

As shown in FIG. 1C and for at least one implementation, the system 100 may be used with multiple users in a given environs. A user (as identifiable by an associated wearable device) may be associated with an age identifier by the hub 102. For example, an adult user “U”, a senior user “S” (such as, and not by limitation, a person over sixty-five (65) years of age), or a child/youth user “Y” (such as, and not by limitation, a person under thirteen (13) years of age) identifier may be used.

The hub 102 may be further operable to adjust one more sounds output by one or more speakers 106-M based upon preferences associated with a given user, the user's age, preferences a given user or preferences for a collection of users such as a family preference, or otherwise. The hub 102 may be further operable to adjust the one or more sounds output by one or more speakers 106-M based on a proximity of one or more users, as determined based on a location of a given wearable device 126, to a given speaker 106-M, a given user's movements, or otherwise. For example and not by limitation, the hub 102 may be operable to adjust sounds output by the first speaker 106-1 (e.g., increasing the volume) the second speaker 106-2 (e.g., decreasing the volume) and the third speaker 106-3 (e.g., muting the speaker) when the senior user S is at the first location S(1) and proximately located near the second speaker 106-2. Likewise, the hub 102 may be operable to adjust sounds output by one or more speakers based upon movements of a child/youth user Y. For example, the hub 102 may be operable to mute profanity in a given content when the child/youth user Y moves from the bedroom 118 location, as represented by location Y(4), and into the dining area 116, as represented by location Y(3).

As shown in FIG. 2, the system may include a hub 102 coupled to at least one wearable device 126 using a first wireless connection 130. The wearable device 126 may be coupled to a first access point 128 over a second wireless connection 132, to a second access point 134 over a third wireless connection 136 and to one or more Nth access points 234 over one or more Nth wireless connections 232.

### Hub 102

The hub 102 may include a processor module 204 configured to provide, at least, a user engine 206 and a sounds engine 208. The processor module 204 may be operable to perform any data, sound, and/or signal processing capabilities. For at least one implementation, the processor module 204 may have access to one or more non-transient processor readable instructions, including instructions for executing one or more applications, engines, and/or processes configured to instruct the processor to perform computer executable operations (hereafter, “computer instructions”). The processor module 204 may use any known or later arising processor capable of providing and/or supporting the features and functions of the hub 102 and in accordance with one or more of the various implementations of the present disclosure. For at least one non-limiting implementation, the processor module 204 may be configured as and/or has the capabilities of a 32-bit or 64-bit, multi-core ARM based processor. For at least one implementation, the hub 102 may arise on one or more backend systems, such as server systems or otherwise.

The processor module 204 may be configured to execute computer instructions and/or data sets obtained from one or more storage modules 212. The hub 102 may include a wearable device interface module 210. It is to be appreciated that the storage module 212 may be configured using any known or later arising data storage technologies. In at least one implementation, the storage module 212 may be configured using flash memory technologies, micro-SD card technology, as a solid-state drive, as a hard drive, as an array of storage devices, or otherwise. The storage module 212 may be configured to have any data storage size, read/write speed, redundancy, or otherwise. The storage module 212 may be configured to provide temporary/transient and/or permanent/non-transient storage of one or more data sets, computer instructions, and/or other information. Data sets may include, for example, information specific to a user, such as those provided by a user preference database 214, information relating to one or more sounds, such as those provided by a sounds database 218, or other information. Computer instructions may include firmware and software instructions, and data for use in operating the hub 102. Such data sets may include software instructions configured for execution by the processor module 204, another module of the hub 102, a wearable device 126, or otherwise. Such computer instructions provide computer executable operations that facilitate one or more features or functions of a hub 102, a wearable device 126, or otherwise. The storage module 212 may be further configured to operate in combination and/or conjunction with one or more servers (not shown). The one or more servers may be coupled to the hub 102, a wearable device 126, a remote storage device (not shown), other devices that are internal and/or external device to the hub 102 and/or the wearable device 126, or otherwise. The server(s) may be configured to execute computer instructions which facilitate the providing of an adaptive audio environment based on user location and in accordance with at least one implementation of the present disclosure. For at least one implementation, one or more of the storage components may be configured to store one more data sets, computer instructions, and/or other information in encrypted form using known or later arising data encryption technologies.

The hub 102 may include a speaker(s) interface 219. The speaker(s) interface 219 may be operable to directly or indirectly, for example by use of a source 104, control one or more sound properties output by one or more speakers 106 and using one or more hub-to-speaker connections 236. The hub 102 may include a source interface 220 that couples the hub 102 to a source 104 using a hub-to-source connection 238. Via the source interface 220, the processor 204 may provide instructions to the source 104 which instruct the source 104 to adjust one or more sound properties to be output by one or more speakers 106. The source 104 may be coupled to the one or more speakers 106 using one or more source-to-speaker connections 240. It is to be appreciated that the hub-to-speaker connections 236, hub-to-source connections 238, and source-to-speaker connections 240 may use any known or later arising signal coupling technologies.

The wearable device interface module 210 may be operable to facilitate communications between the hub 102 and a wearable device 126. The wearable device interface module 210 may utilize any known or later arising technology to establish, maintain, and operate one or more links between the hub 102, the wearable device 126, any remote servers, any remote storage devices, or other devices. Such links may arise directly, as illustratively shown by first wireless connection 130, or using any wireless networking and/or wireless communications technologies. Non-limiting examples of technologies that may be utilized to facilitate such communications in accordance with one or more implementations of the present disclosure include, but are not limited to, Bluetooth, ZigBee, Near Field Communications, Narrowband IOT, WIFI, 3G, 4G, 5G, cellular, and other currently arising and/or future arising wireless communications technologies. The wearable device interface module 210 may be configured to include one or more data ports (not shown) for establishing connections between a hub 102 and another device, such as a laptop computer. Such data ports may support any known or later arising technologies, such as USB 2.0, USB 3.0, ETHERNET, FIREWIRE, HDMI, and others. The wearable device interface module 210 may be configured to support the transfer of data formatted using any protocol and at any data rates/speeds. The wearable device interface module 210 may be connected to one or more antennas (not shown) to facilitate wireless data transfers. Such antenna may support short-range technologies, such as 802.11a/c/g/n and others, and/or long-range technologies, such as 4G, 5G, and others. The wearable device interface module 210 may be configured to communicate signals using terrestrial systems, space-based systems, and combinations thereof systems. For example, a hub 102 may be configured to receive GPS signals from a satellite directly, by use of a wearable device 126, or otherwise.

The processor module 204 may be configured to facilitate one or more computer engines, such as a user engine 206 and a sound engines 208. As discussed in further detail below, the engines may be configured to execute at least one computer instruction. For at least one implementation, the user engine 206 provides the capabilities for the hub 102 and wearable device 126 to determine a current location for a given wearable device 126 and output one or more data sets identifying at least one characteristic of an adaptive audio environment, at a given time, in view of at least one or more user preferences associated with the given wearable device 126 and the current location of the wearable device 126.

For at least one implementation, the sounds engine 208 provides the capabilities for the hub 102 to identify and provide an adaptive audio environment, at any given time, in view of the one or more data sets output by the user engine 206 and in view of data provided by a speaker database 216 and/or a sounds database 218. The user engine 206 may utilize data obtained from the storage module 212 and/or from a remote storage device (not shown). The sounds engine 208 may utilize such data to instruct modifications, or a maintaining of current settings, of one or more sound properties for sound output by one or more speakers 106 within a given environ. It is to be appreciated, that the data provided in the user preferences database 214, speaker database 216, and/or sounds database 218 may be provided and/or augmented using data stored in a wearable device 126, based upon user inputs, such as a user's manual adjustment of a sound property, or otherwise. Further, it is to be appreciated that data sets in any given storage component may be updated, augmented, replaced, or otherwise managed based upon any then arising or future arising audio environment to be generated for a given user.

### Wearable Device 126

As further shown in FIG. 2 and for at least one implementation of the present disclosure, a wearable device 126 may be configured to capture, monitor, detect and/or process a user's then arising sound environment, location, and motion and, in response thereto and/or in anticipation thereof, provide an adaptive audio environment. For at least one implementation, the wearable device 126 may include a sound sensor 222, a location detector 224, and a motion sensor 226. Other sensors and/or detectors (herein, “sensors”) may be utilized. Any types, combinations, permutations and/or configurations of one or more sensors may be used in an implementation of the present disclosure.

For at least one implementation, a wearable device 126 may include one or more sound sensors 222 configured to capture, monitor, detect and/or process sounds present at a user's current location, including sound properties of sounds output by the speakers 106—when such sound properties are present at the current location of the wearable device. Sound sensor 222 may be operable to detects sounds originating in any sound-field, such as a frontal field, a 360-degree field, or otherwise. Sound sensor 222 may provide for sound field monitoring, filtering, processing, analyzing and other operations at any one or more frequencies or ranges thereof. Sound sensor 212 may be configured to filter, enhance, or otherwise process sounds to minimize and/or eliminate noise, enhance certain sounds while minimizing others, or as otherwise configured by a user, a computer instruction executing by a wearable device 126 or a hub 102, or otherwise. Sounds captured by the sound sensor 222 may be proceed by sound processing capabilities provided by the sound sensor 222, the wearable device 126, the hub 102, a server (not shown), and/or any combinations or permutations of the foregoing.

For at least one implementation, a wearable device 126 may include one or more location detectors 224 configured to capture, monitor, detect and/or process a current location of a wearable device 126. Non-limiting examples of location detectors include those using global positioning satellite (GPS) system data, detectors that utilize triangulation and timing principles from three or more radio frequency emitters, detectors that utilize phase delays in transmitted sound signals, and otherwise. Data from location detector 224 may be processed by processing capabilities provided by the location detector 224 itself, the wearable device 126, the hub 102, a server (not shown), and/or any combinations or permutations of the foregoing.

For at least one implementation, a wearable device 126 may include one or more motion sensors 226 configured to capture, monitor, detect and/or process a user's change of motion or orientation, such as by acceleration, deceleration, rotation, inversion, or otherwise. A non-limiting example of a motion sensor is an accelerometer. Data from the motion sensor 226 may be processed by processing capabilities provided by the motion sensor 226 itself, the wearable device 126, the hub 102, a server (not shown), and/or any combinations or permutations of the foregoing.

For at least one implementation, a wearable device 126 may include one or more user interfaces 228. The user interfaces 228 may be operable to facilitate interaction by a given user with a given wearable device 126. Such interactions may occur by use of buttons, touch interfaces, motions, speech, or otherwise. The user interfaces 228 may include audio output device(s) (not shown) configured to provide audible sounds to a user. Examples of audio output device(s) include one or more ear buds, headphones, speakers, cochlear implant devices, and the like. Audible signals to be output by a given audio output device may be processed using processing capabilities provided by the audio output device, the wearable device 126, the hub 102, a server (not shown), and/or any combinations or permutations of the foregoing.

For at least one implementation, a wearable device 126 may include a device interface 230. The device interface 230 may be operable to facilitate communications between the wearable device 126 and one or more of the hub 102, a first access point 128, a second access point 134, an Nth access point, 234, a GPS satellite, a server (not shown), and otherwise. The device interface 230 may utilize any known or later arising technology to establish, maintain, and operate one or more of the first wireless connection 130, the second wireless connection 132, the third wireless connection 136, the Nth wireless connection 232, and any wireless connections with a server, any remote storage devices. or other devices. Such connections may arise directly, as illustratively shown by the first wireless connection 130, or using any wireless networking and/or wireless communications technologies. Non-limiting examples of technologies that may be utilized to facilitate such communications in accordance with one or more implementations of the present disclosure include, but are not limited to, Bluetooth, ZigBee, Near Field Communications, Narrowband IOT, WIFI, 3G, 4G, 5G, cellular, and other currently arising and/or future arising wireless communications technologies. The device interface 230 may be configured to include one or more data ports (not shown) for establishing connections between a hub 102 and another device, such as a laptop computer. Such data ports may support any known or later arising technologies, such as USB 2.0, USB 3.0, ETHERNET, FIREWIRE, HDMI, and others. The device interface 230 may be configured to support the transfer of data formatted using any protocol and at any data rates/speeds. The device interface 230 may be connected to one or more antennas (not shown) to facilitate wireless data transfers. Such antenna may support short-range technologies, such as 802.11a/c/g/n and others, and/or long-range technologies, such as 4G, 5G, and others. The device interface 230 may be configured to communicate signals using terrestrial systems, space-based systems, and combinations thereof systems. For example, a wearable device 126 may be configured to receive GPS signals from a satellite directly, or otherwise.

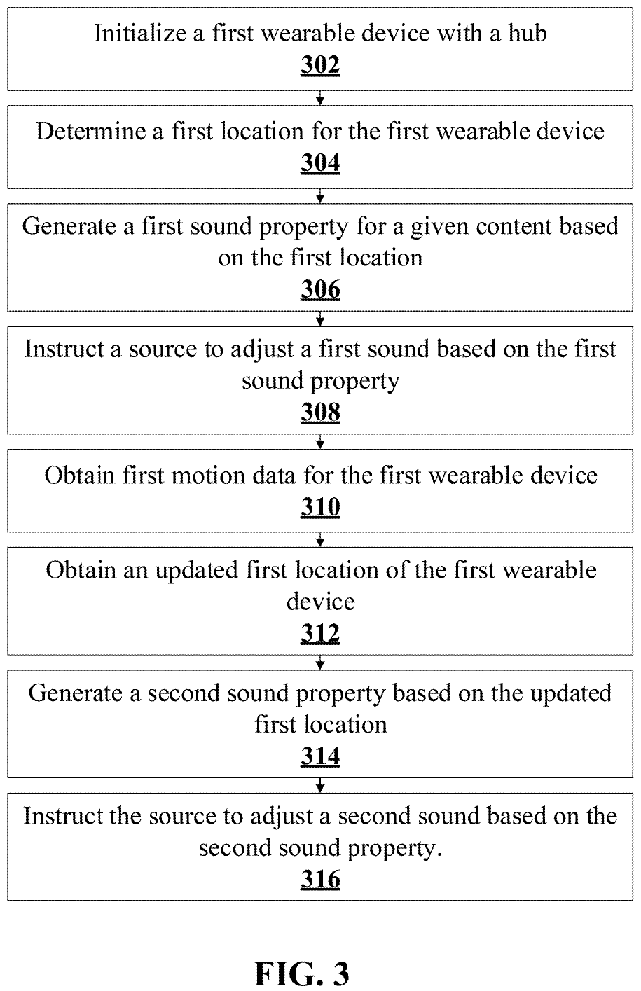

In FIG. 3, one implementation is shown of a process for providing an adaptive audio environment based on a current location of a user.

In Operation 302, the process may begin with initializing a wearable device 126, a hub 102, and a source 104. Initialization may involve loading default data into one or more of the user preferences database 214, speaker database 216, and/or sounds database 218.

In Operation 304, the process may include obtaining user preference data. This determining may occur on one or more of the wearable device 126 and the hub 102. User specific data may include user preferences, sounds, speakers, source properties, and other information. It is to be appreciated that audio output devices, sensors, and other components available to a user may vary by environ. Thus, Operation 302 may be considered as including determinations to characterize components (audio, sensors, data or otherwise) available to a user, by which and with which a system may provide an adaptive audio environment in view of a current location of the user, as represented by a current location of a given wearable device 126 associated with a given user 124. Such user data and/or other data may be available, for example, from a previously populated user preferences database 214, a previously populated speaker database 216, a previously populated sounds database 218, based upon information received by a hub 102 from a source 104, or otherwise. The user preferences database 214 may include one or more tags, identifiers, metadata, user restrictions, use permissions, preferences, disabilities, demographics, psychographic s, or other information that the hub 102 may utilize in adjusting one or more sound properties, as generated by one or speakers, and in view of a current location of wearable device associated with the given user. User data may also be available in the form of external data.

In Operation 306, the process may include determining a current location of the wearable device 126.

In Operation 308, the process may include generating one or more first sound properties based on the user preference data and the current location of the wearable device.

In Operation 310, the process may include adjusting sounds output by one or more speakers 106 based on the one or more first sound properties.

In Operation 312, the process may include receiving motion data for the wearable device 126. The motion data may be generated by a motion sensor 226 in the wearable device 126. The motion data may be indicative of a wearable device 126 changing locations within a given environ. Accordingly, when generated, the process may proceed to Operation 314. When no motion data is received, the process may be placed held in a hold status until motion data is generated and/or an “End” activity arises, such as user turning off one or more of the source, the hub, the wearable device, or otherwise.

In Operation 314, the process may include obtaining a second location of the wearable device.

In Operation 316, the process may generating one or more second sound properties based on the second location data.

In Operation 318, the process may include adjusting the sounds output by the one or more speakers based on the one or more second sound properties.

The process may then continue until new motion is obtained or until the process ends, as further described above in Operation 312.

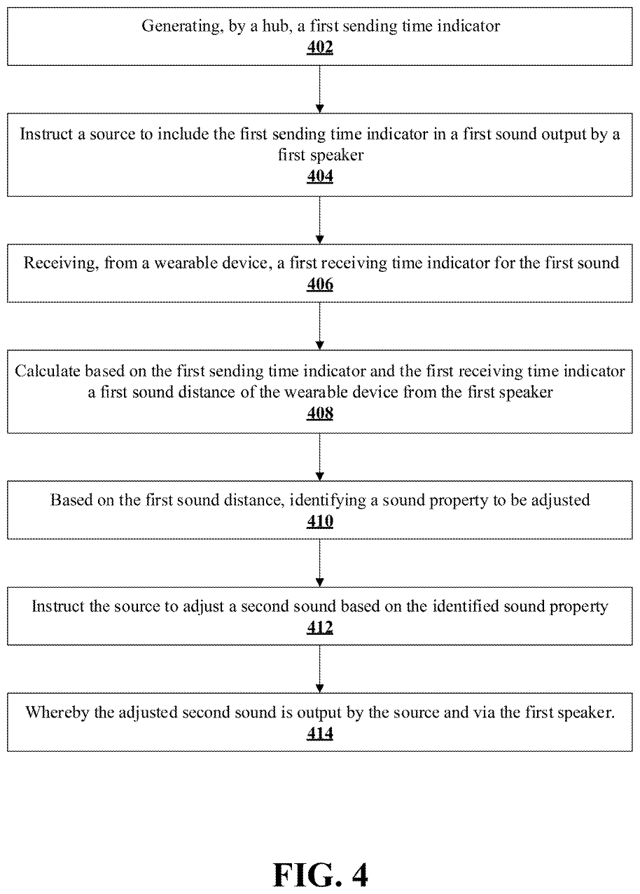

In FIG. 4, a process is shown for providing an adaptive audio environment based on a sound distance of a wearable device from a hub and in accordance with an implementation of the present disclosure. As used herein, a “sound distance” is a distance for a sound wave to travel from a first location, such as a first speaker, to a second location, such as a current location of a wearable device. As used herein, the actual distance traveled by a given sound is largely not relevant. The effective sound received by a user at a current location from one or more speakers is relevant. One or more sound properties of a sound received at a current location may also be relevant for one or more implementations. It is to be appreciated that as a user moves about an environ, sound properties of sounds output by a given speaker and received at a given location may be impacted in some form based upon distance of the user from the speaker. For example, the sound volume may be diminished, attenuated, distorted, or otherwise effected. The hub may be programmed, based upon trial and use, measurements, or otherwise to adjust sound properties based upon determined sound distances.

The process may include, per Operation 402, generating, by a hub, a sending time indicator. As used herein, a sending time indicator can be of any form. Non-limiting examples, include a phase variance, a frequency, a volume variance, or any other analog or digital signal which a receiving wearable device may use to determine a relative time at when the sound including the sending time indicator is output by a given speaker.

Per Operation 404, the process may include instructing a source to include the sending time indicator in a first sound to be output by a first speaker -where the first speaker is coupled to the source. The first speaker outputs the sound with the sending time indicator.

Per Operation 406, the process may include receiving, from a wearable device, a receiving time indicator for the first sound. The receiving time indicator may be communicated by the wearable device to the hub using, for example, the first wireless connection. The receiving time indicator may include a time mark at which the wearable device received the first sound that includes the sending time indicator.

Per Operation 408, the process may include calculating, by the hub, and based on the sending time indicator and the receiving time indicator received from the wearable device, a sound distance of the wearable device from the first speaker.

Per Operation 410, the process may include identifying, by the hub, a sound property to be adjusted. Such adjustments may be further made in view of a given user's preferences, speaker data, sounds data, and the like.

Per Operation 412, the process may include the hub instructing the source to adjust a second sound based on the identified sound property.

Per Operation 414, source outputs, via the first speaker, an adjusted second sound. It is to be appreciated that sound properties for sounds output by any second and/or successive speakers may be accomplished until a given sound envelope is provided, by multiple speakers, to a given user at a given location. It is also to be appreciated that a given location of a user/wearable device may be determined based upon determinations of multiple sound distances from multiple speakers.

The various operations shown in FIG. 3 are described herein with respect to at least one implementation of the present disclosure where a first user is present in an environ. It is to be appreciated that when multiple users are present in a given environ, the hub 102 may be configured to dynamically adjust one or more sound properties based upon current locations and second locations of one or more of the two or more users, preferences of such two or more users, speaker locations, and otherwise. The described operations may arise in the sequence described, or otherwise and the various implementations of the present disclosure are not intended to be limited to any given set or sequence of operations. Variations in the operations used and sequencing thereof may arise and are intended to be within the scope of the present disclosure.

Although various implementations have been described above with a certain degree of particularity, or with reference to one or more individual implementations, those skilled in the art could make numerous alterations to the disclosed implementations without departing from the spirit or scope of the claims. The use of the terms “approximately” or “substantially” means that a value of an element has a parameter that is expected to be close to a stated value or position. However, as is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes and are not intended to be limiting to any orientation or configuration of any elements or sequences of operations for the various implementations of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that the matter contained in the above description and shown in the accompanying drawings shall be interpreted as illustrative implementations and not limiting. Changes in detail or structure may be made without departing from the basic elements recited in the following claims.

Further, a reference to a computer executable instruction includes the use of computer executable instructions that are configured to perform a predefined set of basic operations in response to receiving a corresponding basic instruction selected from a predefined native instruction set of codes. It is to be appreciated that such basic operations and basic instructions may be stored in a data storage device permanently, may be updateable, and are non-transient as of a given time of use thereof. The storage device may be any device configured to store the instructions and is communicatively coupled to a processor configured to execute such instructions. The storage device and/or processors utilized operate independently, dependently, in a non-distributed or distributed processing manner, in serial, parallel or otherwise and may be located remotely or locally with respect to a given device or collection of devices configured to use such instructions to perform one or more operations.

What is claimed is:

1. A process, for adapting an audio environment based on a current user location, comprising:
initializing a first wearable device with a hub;
determining a first location for the first wearable device;
generating a first sound property for a given content based on the first location;
instructing a source to adjust a first sound based on the first sound property;
obtaining first motion data for the first wearable device;
obtaining an updated first location of the first wearable device;
generating a second sound property based on the updated first location; and
instructing the source to adjust a second sound based on the second sound property.

2. The process of claim 1,
wherein the first wearable device comprises at least one of a smartphone, a smart watch, a laptop computer, and a fitness tracker.

3. The process of claim 1,
wherein the first location and the updated first location for the first wearable device are determined by:
establishing a first wireless connection between the first wearable device and the hub;
establishing a second wireless connection between the first wearable device and a first access point;
establishing a third wireless connection between the first wearable device and a second access point; and
calculating the first location and the updated first location by triangulating timing signals communicated respectively between the first wearable device with the hub, the first access point, and the second access point over the first wireless connection, the second wireless connection, and the third wireless connection.

4. The process of claim 1,
wherein at least one of the first location and the updated first location is determined by a global positioning system receiver in the first wearable device.

5. The process of claim 1,
wherein the first sound property is a volume setting for a first speaker; and
wherein the second sound property is a second volume setting for the first speaker.

6. The process of claim 1,
wherein the first sound property is a volume setting for a first speaker; and
wherein the second sound property is a volume setting for a second speaker.

7. The process of claim 1, further comprising:
adjusting the second sound property based upon a first user preference;
wherein the adjusting of the second sound property includes an increase in a volume setting when the first user preference indicates a first user of the first wearable device is hearing impaired; and
wherein the adjusting of the second sound property includes a reduction in the volume setting when the updated first location is associated with a bedroom.

8. The process of claim 1, further comprising:
initializing a second wearable device with the hub;
obtaining a second location for the second wearable device;
generating a third sound property for the given content based on the second location;
instructing the source to adjust the first sound based on at least one of the first sound property and the third sound property;
obtaining second motion data for the second wearable device;
obtaining an updated second location of the second wearable device;
generating a fourth sound property based on the updated second location; and
instructing the source to adjust the second sound based on at least one of the second sound property and the fourth sound property.

9. The process of claim 8, further comprising:
adjusting the second sound property based upon a second user preference;
wherein the second user preference indicates that a second user of the second wearable device is a child; and
wherein the adjusting of the second sound property includes muting sounds based on the updated second location.

10. A process, for adjusting sounds based on a location of a wearable device from a hub, comprising:
generating, by a hub, a first sending time indicator;
instructing a source to include the first sending time indicator in a first sound output by a first speaker;
receiving, from a wearable device, a first receiving time indicator for the first sound;
calculating based on the first sending time indicator and the first receiving time indicator a first sound distance of the wearable device from the first speaker; and
based on the first sound distance,
identifying a sound property to be adjusted; and
instructing the source to adjust a second sound based on the identified sound property; and
whereby the adjusted second sound is output by the source and via the first speaker.

11. The process of claim 10, further comprising:
adjusting the sound property based upon a first user preference; and
wherein the adjusting of the sound property includes an increase in a volume setting when the first user preference indicates a first user of the first wearable device is hearing impaired.

12. The process of claim 10, further comprising:
generating, by the hub, a second sending time indicator;
instructing the source to include the second sending time indicator in a second sound output by a second speaker;
generating, by the hub, a third sending time indicator;
instructing the source to include the third sending time indicator in a third sound output by a third speaker;
receiving, from the wearable device, a second receiving time indicator for the second sound;
calculating based on the second sending time indicator and the second receiving time indicator a second sound distance of the wearable device from the second speaker;
receiving, from the wearable device, a third receiving time indicator for the third sound;
calculating based on the third sending time indicator and the third receiving time indicator a third sound distance of the wearable device from the third speaker; and
determining, by triangulation of the first sound distance, the second sound distance and the third sound distance, a location of the wearable device.

13. A system comprising:
a first wearable device associated with a first user;
a source having a sound processor operable to generate a first sound;
a speaker, coupled to the source, operable to output the first sound; and
a hub, coupled to the source and to the wearable device, comprising:
a processor executing non-transient computer instructions for:
determining a first location and a second location of the first wearable device; and
instructing the source, based on the first location and the second location, to adjust a sound property of the first sound.

14. The system of claim 13,
wherein the sound property is a volume setting; and
wherein the hub instructs the source to set the volume setting at a first setting when the first location is within a first range of the hub; and
wherein the hub instructs the source to set the volume setting at a second setting when a second location is within a second range of the hub.

15. The system of claim 13,
wherein the sound property is frequency setting for the first sound.

16. The system of claim 13,
wherein the non-transient computer instructions further comprise instructions for:
obtaining a user preference for the first user; and
instructing the source to adjust the sound property based on the user preference for the first user.

17. The system of claim 13,
wherein the wearable device further comprises:
a global positioning system (GPS) receiver; and
wherein the wearable device communicates a current location of the user to the hub as determined based on GPS position determinations.

18. The system of claim 13,
wherein the hub is operable to communicate a first timing signal to the wearable device;
wherein the system further comprises:
a first access point, communicatively coupled to the wearable device, operable to communicate a second timing signal to the wearable device; and
a second access point, communicatively coupled to the wearable device, operable to communicate a third timing signal to the wearable device; and
wherein at least one of the hub and the wearable device are operable to determine a current location of the user based upon a triangulation of a first distance, a second distance, and a third distance;
wherein the first distance is based upon a first time difference between when the first timing signal was sent and received by the wearable device;
wherein the second distance is based upon a second time difference between when the second timing signal was sent and received by the wearable device; and
wherein the third distance is based upon a third time difference between when the third timing signal was sent and received by the wearable device.

19. The system of claim 13,
wherein the source is further operable to generate a second sound;
the system further comprises:
a second speaker, coupled to the source, operable to output the second sound; and
a second wearable device, coupled to the hub, associated with a second user;
wherein the non-transient computer instructions further comprise instructions for:
obtaining a second user preference for the second user;
determining a third location of the second wearable device; and
instructing the source, based on the third location, to adjust the sound property of the second sound.

20. The system of claim 13,
wherein the hub is provided in combination with the source.
